(19) United States
(12) Patent Application Publication
(10) Pub. No.: US 2026/0188599 A1
(43) Pub. Date: Jul. 2, 2026

(54) CONTACT SWITCH, SAFETY DOOR AND ELEVATOR SYSTEM

(71) Applicant: Otis Elevator Company, Farmington, CT (US)

(72) Inventors: Jie Hu, Hangzhou (CN); Hua Zhang, Hangzhou (CN); Shan Li, Hangzhou (CN); Haibo Wang, Hangzhou (CN); Guowei Li, Hangzhou (CN)

(21) Appl. No.: 19/395,235

(22) Filed: Nov. 20, 2025

(30) Foreign Application Priority Data
Dec. 30, 2024 (CN) 202411975976.0

(51) Int. Cl. H01H 9/04; B66B 5/00; B66B 13/22

(52) U.S. Cl. CPC H01H 9/04; B66B 5/0031; B66B 13/22

(57) ABSTRACT

A contact switch, a safety door and an elevator system. The contact switch includes a plug and a socket, the plug including a contact head configured in a plate shape, the socket including a housing, an elastic member and a contact point arranged in the housing, the elastic member includes an avoidance portion and a free end extending toward the contact head relative to the avoidance portion, and the contact point is fixed to the free end and extends toward the contact head relative to the free end, when the plug is inserted into the socket, the contact head contacts the contact point to turn on the contact switch and to be spaced apart from the avoidance portion.

### FOREIGN PRIORITY

This application claims priority to Chinese Patent Application No. 202411975976.0, filed Dec. 30, 2024, and all the benefits accruing therefrom under 35 U.S.C. § 119, the contents of which in its entirety are herein incorporated by reference.

### TECHNICAL FIELD OF INVENTION

The present disclosure relates to the field of switches, and more specifically, to a contact switch, a safety door and an elevator system.

### BACKGROUND OF THE INVENTION

This section aims to provide background information related to understanding the various technologies described herein. As implied by the title of this section, this is a discussion of related technologies that should not in any way imply that it is necessarily a prior art. Therefore, it should be appreciated that any statement in this section should be read from this perspective, rather than any acknowledgment of the prior art.

At present, in the elevator industry, contact door switches that play the role of electrically verifying that the door is in place and the door lock is in a locked state mostly adopt pin and socket switch structures. The existing pin and socket switches in the prior art mostly adopt the form of two-pin pins and two working holes on the socket. However, as the protection level of IP2X must be met, the working hole on the socket is small, so that after the pin contacts the socket, the sliding space between the two is small, as large shaking or installation offset may cause damage to the pin. In addition, dust accumulation on the surface of the contact point may cause virtual conduction of the switch. Currently, switches with larger sliding spaces are usually larger in size, and the installation methods and usage space thereof may not meet the usage of conventional elevators.

### SUMMARY OF THE INVENTION

The purpose of the present disclosure is to solve or at least alleviate the problems existing in the prior art.

According to one aspect, a contact switch is provided, wherein the contact switch comprises a plug and a socket, the plug comprising a contact head configured in a plate shape, the socket comprising a housing, an elastic member and a contact point arranged in the housing, where the elastic member comprises an avoidance portion and a free end extending toward the contact head relative to the avoidance portion, and the contact point is fixed to the free end and extends toward the contact head relative to the free end, wherein, when the plug is inserted into the socket, the contact head contacts the contact point to turn on the contact switch and to be spaced apart from the avoidance portion.

Optionally, according to an embodiment of the present disclosure, a limiting portion extending inwardly is configured in the housing, and the limiting portion forms a receiving space, wherein, when the plug is inserted into the socket, the contact head enters the receiving space and is limited in the thickness direction of the contact head through the limiting portion.

Optionally, according to an embodiment of the present disclosure, the contact head comprises a contact head body, a base material disposed on the contact head body, and a contact layer for contacting the contact point, where the base material and the contact layer are connected by thermal compounding.

Optionally, according to an embodiment of the present disclosure, the contact layer contains silver material, and the base material contains copper material.

Optionally, according to an embodiment of the present disclosure, a groove is provided on a side edge of the contact head body, the base material is configured as a U-shaped structure with a joint portion configured on a side edge, wherein, the joint portion is engaged in the groove, and the side edge and bottom edge of the U-shaped structure are respectively attached to a side edge and an end surface facing the socket of the contact head body.

Optionally, according to an embodiment of the present disclosure, the housing is formed with a through opening and an open portion, wherein, the open portion is communicated with the internal space of the housing and is used for the contact head to enter, and the through opening communicates the internal space of the housing with the outside.

Optionally, according to an embodiment of the present disclosure, the end surface of the contact head along the thickness direction is configured with a mark, wherein, in an initial state where the contact switch is not turned on, the mark is visible to the outside, and in a final state where the contact switch is turned on, the mark is at least partially blocked by the socket.

Optionally, according to an embodiment of the present disclosure, the socket comprises at least two baffles, wherein, the baffles are configured on the end surface of the housing facing the plug, and the contact head contacts the contact point through an intermediate space formed between the baffles and the open portion in sequence.

Optionally, according to an embodiment of the present disclosure, the socket comprises a first threaded fastener and a second threaded fastener, wherein, the first threaded fastener fixes the housing along a thickness direction of the housing, and the second threaded fastener is used for wiring and is accessible from outside the housing.

Optionally, according to an embodiment of the present disclosure, the socket comprises a nut that cooperates with the second threaded fastener, and an end surface of the housing along the thickness direction is provided with an opening, and the nut is accessible from outside the housing through the opening.

Optionally, according to an embodiment of the present disclosure, an inner side wall of the housing is configured with an abutment portion, and the bottom surface of the housing along the thickness direction is configured with a limiting column, a guide structure and a receiving portion for receiving the nut, and the elastic member is clamped to an outer wall of the receiving portion through the limiting column and the guide structure, wherein, in the initial state where the contact switch is not turned on, the abutment portion abuts against the avoidance portion.

Optionally, according to an embodiment of the present disclosure, the housing comprises a first sub-housing and a second sub-housing, wherein, the elastic member and the contact point are arranged in the first sub-housing, the open portion and the through opening are opened on the first sub-housing, and the second sub-housing is configured with a hook portion, where when the first sub-housing and the second sub-housing are assembled, the hook portion is clamped to the through opening.

According to another aspect, a safety door is provided, wherein the safety door comprises a contact switch according to any of the above.

According to yet another aspect, an elevator system is provided, wherein the elevator system comprises the above-mentioned safety door.

The contact switch according to the embodiments of the present disclosure effectively prevents the increase of resistance caused by the contact between the contact head and the elastic member when the plug is engaged with the socket in a cost-effective manner.

### BRIEF DESCRIPTION OF THE DRAWINGS

The contents of the present disclosure will become more easily understood with reference to the appended drawings. It is easy for those skilled in the art to understand that these drawings are only for illustrative purposes and are not intended to limit the scope of protection of the present disclosure. In addition, similar numbers in the drawings are used to denote similar components, wherein:

FIG. 1 is a schematic diagram of an exemplary elevator system;

FIG. 2 is a three-dimensional view of a socket according to the present disclosure;

FIG. 3 is a positional relationship diagram of a plug and a socket in an initial state according to the present disclosure;

FIG. 4 is a cross-sectional view of a plug and a socket in a final state according to the present disclosure;

FIG. 5 is a plan view of a plug according to the present disclosure;

FIG. 6 is a plan view of a contact head body according to the present disclosure;

FIG. 7 is a three-dimensional view of a base material and a contact layer according to the present disclosure;

FIG. 8 is a three-dimensional view of a housing according to the present disclosure; and

FIG. 9 is a three-dimensional view of a second sub-housing according to the present disclosure.

### DETAILED DESCRIPTION OF THE INVENTION

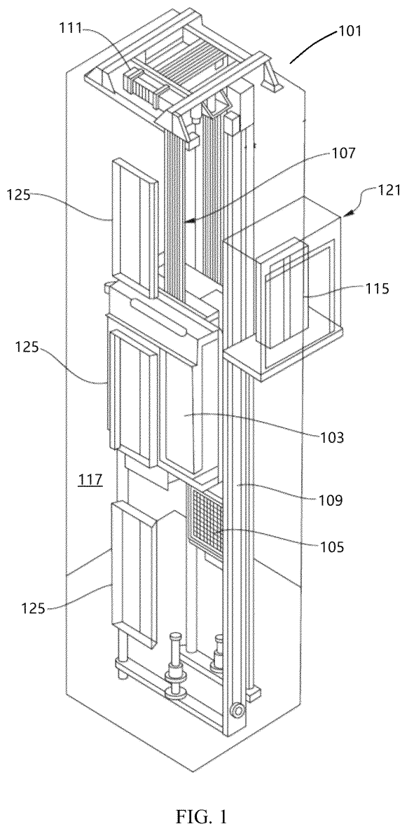

FIG. 1 is a perspective view of an elevator system 101 that includes an elevator car 103, a counterweight 105, ropes 107, guide rails 109, a traction machine 111 and an elevator system controller 115. The elevator car 103 and the counterweight 105 are connected to each other via ropes 107. The ropes 107 may include or be configured as, for example, cords, steel cables and/or a coated steel belt, and in this embodiment, the ropes are configured as a rope belt integrating a plurality of ropes. The counterweight 105 is configured to balance the load of the elevator car 103 and to facilitate synchronized, counter-directional movement of the elevator car 103 relative to the counterweight 105 within an elevator hoistway 117 and along the guide rails 109. The ropes 107 engage with the traction machine 111 which is part of an overhead structure of the elevator system 101. The traction machine 111 is configured to control movement between the elevator car 103 and the counterweight 105.

The elevator system controller 115 as illustrated is positioned within an elevator system controller room 121 of the elevator hoistway 117, and is configured to control operation of the elevator system 101 and in particular the elevator car 103. For example, the elevator system controller 115 may provide a drive signal to the traction machine 111 to control the acceleration, deceleration, leveling, stopping, etc. of the elevator car 103. When moving up or down along the guide rails 109 in the elevator hoistway 117, the elevator car 103 as controlled by the elevator system controller 115 can stop at one or more landings 125. Although the elevator system controller 115 is shown within the elevator system controller room 121, a person skilled in the art will appreciate that the elevator system controller 115 may be located and/or configured at other position or location within the elevator system 101. The traction machine 111 may include a motor or a similar drive mechanism.

Although a rope system has been presented and described, elevator systems that utilize other methods and mechanisms for moving an elevator car within an elevator hoistway may also implement the embodiments of the present disclosure. FIG. 1 is a non-limiting example presented for illustrative and explanatory purposes only.

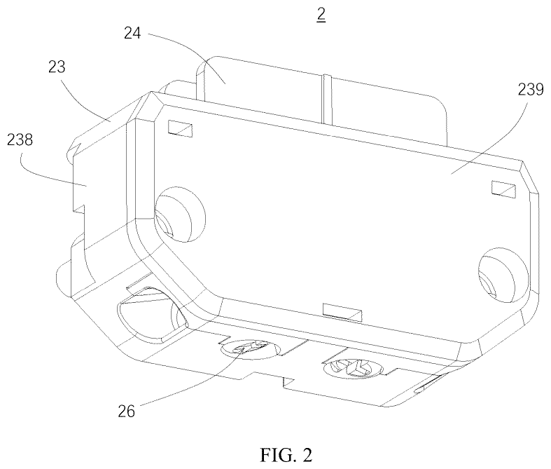

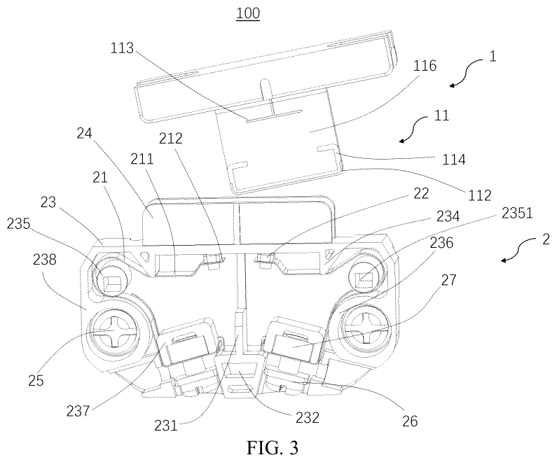

FIG. 2 is a three-dimensional view of a socket according to the present disclosure, and FIG. 3 is a positional relationship diagram of a plug and a socket in an initial state according to the present disclosure.

The present disclosure relates to a contact switch 100, wherein the contact switch 100 comprises a plug 1 and a socket 2. The plug 1 comprises a contact head 11 configured in a plate shape. The socket 2 comprises a housing 23, and an elastic member 21 and a contact point 22 arranged in the housing 23, wherein the elastic member 21 comprises an avoidance portion 211 and a free end 212 extending toward the contact head 11 relative to the avoidance portion 211, the contact point 22 is fixed to the free end 212 and extends toward the contact head 11 relative to the free end 212, where when the plug 1 is inserted into the socket 2, the contact head 11 contacts the contact point 22 to turn on the contact switch 100 and is spaced apart from the avoidance portion 211.

It should be appreciated that the contact switch realizes the switching on or off of the entire switch, or the switching on and off of the circuit associated with the switch, by connecting and disconnecting the contact head of the plug and the contact point of the socket. It can be used for circuit control, signal transmission, safety protection, status indication, and the like. For example, when the contact switch is applied to the hall door or car door of the elevator system, when the contact switch is switched on, it can indicate the closed state of the elevator door, so that the elevator can go up and down normally, otherwise it cannot go up and down. Of course, in addition to the application scenarios of safety doors such as elevator doors, the contact switch can also be used in other scenarios such as access control systems where it is necessary to confirm whether the relative position or state between two components is in place, such as whether the door is correctly opened or closed. In this regard, the plug and socket of the contact switch can be respectively arranged on the two movable parts of the door for realizing the opening and closing of the door, and the on or off state of the contact switch is triggered by the opening and closing movements of the movable parts. In the process from off to on, the contact head moves and contacts the contact point, and the elastic member undergoes a certain deformation accordingly, conforming to the shape and position of the contact head, and ensures a reliable contact between the contact head and the contact point through reaction force. In the process from on to off, the contact head moves away from the contact point, and the elastic member uses elasticity to drive the contact point back to the initial position to achieve reset to prepares for the next turn-on process. The socket is sometimes also called the switch body.

In this technical solution, the contact head is constructed in a plate shape, so the contact head or the entire plug can also be called an insert piece. This technical solution also makes a special design for the avoidance portion and the free end of the elastic member, so that when the contact switch is turned on, the contact head is spaced apart from the avoidance portion of the elastic member. In this way, it is possible to prevent the increase in resistance caused by the contact between the contact head and the elastic member when the plug and the socket are engaged in a cost-effective manner, ensure the priority contact between the contact head and the contact point, and improve the safety and stability of the contact switch. It should be appreciated that the increase in resistance will lead to voltage drop. Especially in actual use, since there may be more than one, even dozens or hundreds of contact switches working in series, the voltage drop effect may be more obvious, so that even if the contact switch is actually in the on state, it will be judged as the off state, thus affecting the normal operation of the elevator system or other equipment using the contact switches. Exemplarily, the elastic member can be constructed into a U-shaped structure, wherein the avoidance portion corresponds to the bottom edge of the U shape, and the free end corresponds to the end of the side edge of the U shape, so that the free end extends toward the plug relative to the avoidance portion, which helps the contact point arranged at the free end to contact the contact head prior to the elastic member, thus avoiding the increase in resistance.

It can also be appreciated that the U-shaped structure described herein is not strictly required, as long as a part of the elastic member generally has the bottom edge and side edge of the U shape, and modifications in details are allowed. For example, there can be a bending structure between the bottom edge and the side edge of the U shape, so as to adaptively adjust the positions of the free end and the contact point according to actual needs.

The elastic member can be, for example, an elastic piece, or can be made of copper, which has the advantages of good elasticity, excellent corrosion resistance, easy processing and manufacturing, non-magnetism, high strength and fatigue resistance, and the like. In addition, the present disclosure has no special restrictions on the shape of the contact point. For example, the contact point can be a square contact point, a circular contact point or a triangular contact point, etc., and the working surface is an arc surface, which is easy to manufacture, increases the contact area, and makes the connection more stable. The arc-surface contact point can also make the current more evenly distributed on the surface of the contact point, reduce the contact resistance, avoid the burning or overheating of the contact point caused by excessive local current density, reduce the heat accumulation caused by excessive resistance, reduce the wear of the contact point, and extend the service life of the contact point. The arc-surface contact point can quickly extinguish the electric arc when separated, reduce the erosion of the electric arc on the contact point, and avoid failures caused by transient voltage. In addition, the contact between the arc-surface contact point and the strip-shaped plug can also effectively remove the dust on the contact point to prevent it from being virtually turned on due to dust accumulation.

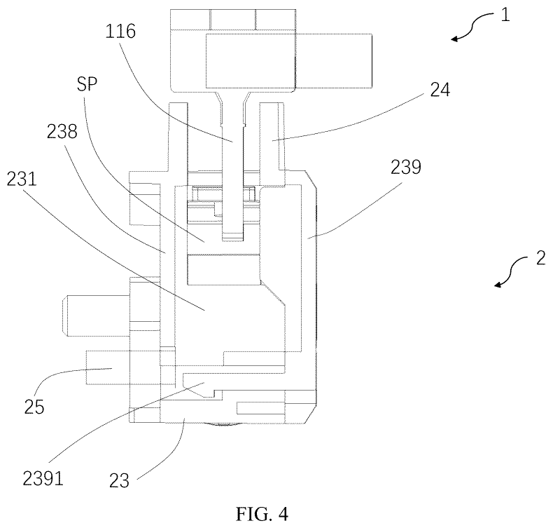

FIG. 4 is a cross-sectional view of a plug and a socket in a final state according to the present disclosure.

A limiting portion 231 extending inward is provided inside the housing 23, and the limiting portion 231 forms a receiving space SP. When the plug 1 is inserted into the socket 2, the contact head 11 enters the receiving space SP and is limited in the thickness direction of the contact head 11 through the limiting portion 231.

Through the design of the limiting portion and the receiving space, the position of the contact head in the turned-on state can be limited as needed, so that the contact head can always contact the contact point without slipping, thus ensuring the stability of the turn-on connection, and in particular preventing the contact head from entering between the elastic member and the inner wall of the housing. It should be noted that this technical solution can be used in cooperation particularly well with the contact head in the shape of an insert piece. If the contact head is a pin structure, it is easy to slip off the contact point and is difficult to limit due to the small volume or occupied space of the pin structure. In contrast, the shape of the insert piece is relatively large and is of a continuous structure, so the limitation of the two side portions of the shape of the insert piece, i.e., the part in contact with the contact head, can be indirectly achieved by limiting the shape of the insert piece (e.g., the middle part thereof) through the limiting portion, so as to ensure the connection stability.

Specifically, the housing 23 comprises a first sub-housing 238 and a second sub-housing 239, and the limiting portion can be jointly formed by these two sub-housings respectively. From the perspective of FIG. 4, the limiting portion is exemplarily configured as a plate shape with a narrow top and a wide bottom in the first sub-housing, and a plate shape with a wide top and a narrow bottom in the second sub-housing, and fits each other in the lower area, and forms a receiving space in the upper area, thereby defining the range of movement of the contact head. Those skilled in the art can flexibly adjust the structure of the limiting portion according to actual needs. The size of the receiving space in the thickness direction can correspond to, or be slightly larger than or smaller than the corresponding size of the contact point, which can better ensure the stable contact between the contact head and the contact point. In addition, the design of the limiting portions fitting each other in the lower area can also facilitate the assembly process of the two sub-housings.

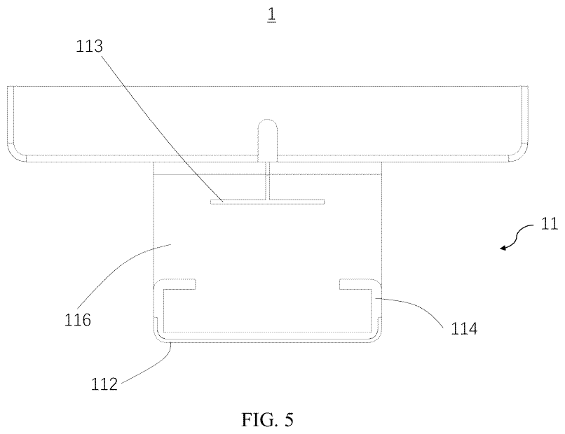

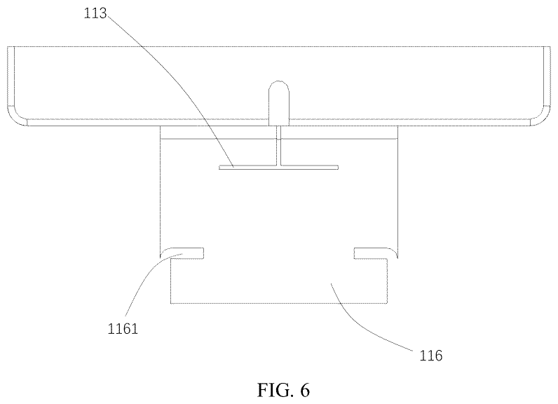

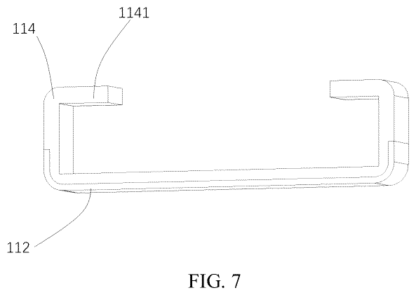

FIG. 5 is a plan view of a plug according to the present disclosure, FIG. 6 is a plan view of a contact head body according to the present disclosure, and FIG. 7 is a three-dimensional view of a base material and a contact layer according to the present disclosure.

The contact head 11 comprises a contact head body 116, a base material 114 disposed on the contact head body 116, and a contact layer 112 for contacting the contact point 22, where the base material 114 and the contact layer 112 are connected by thermal compounding.

This technical solution refines the design of the contact head, wherein the contact layer is used to contact the contact point to turn on the contact switch. Here, the thermal compounding connection can improve the reliability of the connection. Specifically, the thermal compounding connection usually refers to closely combining two or more materials under heating conditions. This connection method can form a strong intermolecular bonding force, thereby ensuring that the connection between the base material and the contact layer is both firm and stable, and this stability is crucial to the performance of the contact head during long-term use. The base material and the contact layer each have different functions. By combining them together through thermal compounding connection, they can complement each other in terms of performance, and improve the overall performance of the contact head, such as improving the conductive efficiency, reducing the contact resistance, and extending the service life. As for thermal compounding itself, thermal compounding connection usually has higher production efficiency. It can achieve large-area, high-strength connection in a short time, thereby shortening the manufacturing cycle of the contact head. In addition, in some applications, other connection methods can also be used, such as mechanical fixing, welding, bonding, and the like.

On the other hand, base materials and contact layer materials with different properties can also be selected to meet specific application requirements. For example, the base material may focus on mechanical strength and thermal conductivity, while the contact layer may focus more on electrical conductivity, wear resistance or corrosion resistance. This flexibility in material selection allows the contact head to be optimized for specific applications.

For example, the contact layer 112 contains silver material, and the base material 114 contains copper material. The thermal compounding of these two materials can achieve a good compromise and balance between performance and cost. Specifically, the use of silver material can significantly reduce the connection resistance and improve the transmission efficiency. Silver also has high corrosion resistance and can resist chemical reactions and oxidation in some environments, ensuring that the contact layer can still operate stably under harsh conditions, thereby extending the life of the contact head. As a base material, copper can ensure that the current flows smoothly inside the contact head and forms a good electrical conduction path with the silver contact layer. By using silver in the contact layer, which acts as a key contact part, and using lower-cost copper in the base material as a support and conductive basis, costs can be reduced while maintaining excellent conductive properties. For thermal compounding, silver and copper are two metals with good compatibility. They can form a good metallurgical bond during the thermal compounding connection process, which can provide greater adhesion between the silver layer and the copper layer, improve the connection reliability and stability of the contact head, and reduce electrical failures caused by poor contact. Therefore, this technical solution has special technical effects not only in the silver and copper materials themselves, but also in matching with thermal compounding.

In terms of material size, as an example only, the thickness of silver is 0.3 mm, and the total thickness of silver and copper after compounding is 0.8 mm. To achieve good balance in performance, life and cost as mentioned above, those skilled in the art can flexibly adjust the silver layer, base material and the total thickness after compounding according to factors such as actual requirements or budget, but will not deviate from the gist of this solution. In addition, although not explained in detail in the present disclosure, those skilled in the art can also select other materials according to budget and requirements. For example, gold, platinum, nickel, etc. can be used for the contact layer, and aluminum, iron, alloy, etc. can be used for the base material. The most suitable combination of the base material and contact layer material for a specific application can be selected by weighing factors such as matching degree with the connection method, conductivity, mechanical strength, corrosion resistance, cost and application environment.

It can also be seen from FIGS. 5 to 7 that a groove 1161 is provided on a side edge of the contact head body 116, the base material 114 is configured as a U-shaped structure with a joint portion 1141 provided on the side edge, the joint portion 1141 is engaged in the groove 1161, and the side edge and bottom edge of the U-shaped structure are respectively attached to the side edge and the end face facing the socket 2 of the contact head body 116.

The technical solution makes a special design for the connection method between the base material and the contact head body, which can be summarized as a method in which the base material is embedded in the contact head body, thus forming a tight mechanical connection, improving the connection reliability, and preventing the base material from falling off. And, through the design of the groove and the joint portion, the assembly process of the contact head body and the base material can be simpler and faster, which can improve production efficiency and reduce manufacturing costs. In addition, the U-shaped base material increases the contact area with the contact head body, which is conducive to heat conduction and heat dissipation, and can provide a certain support strength, so that the contact head can better withstand mechanical stress and impact load. Some other connection methods, such as screw connection, snap-fit connection, welding, riveting, gluing, stitching, etc., can also be applied according to the situation.

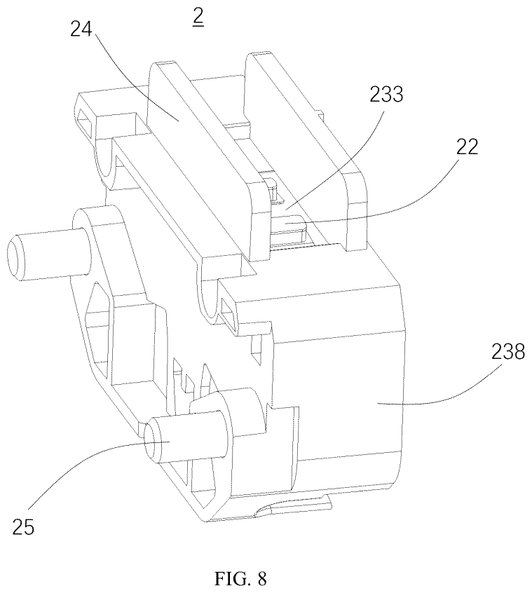

FIG. 8 is a three-dimensional view of a housing according to the present disclosure.

The housing 23 is formed with a through opening 232 and an open portion 233. The open portion 233 is communicated with the internal space of the housing 23 and is used for the contact head 11 to enter, and the through opening 232 communicates the internal space of the housing 23 with the outside.

It can be seen from this technical solution that the open portion can be regarded as a window of the socket to the outside, and the contact head of the plug enters the internal space of the housing of the socket through the open portion to contact the contact point. Therefore, the open portion is exemplarily opened on the end surface of the housing facing the plug. In particular, the larger open portion ensures a larger sliding distance between the plug and the socket, thereby reducing the damage to the switch caused by the shaking of the elevator mechanical parts or other parts for switch installation, and improving the fault tolerance of switch installation.

Also due to the design of the open portion, depending on the actual use environment of the contact switch, impurities such as sand, dust, water, etc. may invade into the socket housing through the open portion and accumulate over time, thereby posing a risk of hindering the movement of the elastic member and the engagement of the contact head. To this end, the technical solution also designs a through opening, so that these invading impurities can be smoothly discharged to the outside, that is, outside the contact switch, thus ensuring the normal operation of the contact switch. For example, the through opening is designed to be larger in size to improve the discharge capacity, and is arranged in the lower area of the housing, so that more impurities can be received. If necessary, more through openings can also be provided. In addition, the presence of the opening also allows air circulation between the inside and outside of the housing, thereby facilitating heat dissipation.

As can be seen in conjunction with FIG. 3 that the end surface of the contact head 11 along the thickness direction is constructed with a mark 113. In the initial state where the contact switch 100 is not turned on, the mark 113 is visible to the outside. In the final state where the contact switch 100 is turned on, the mark 113 is at least partially blocked by the socket 2.

Thus, it can be seen from this technical solution that the mark can be used to intuitively and easily determine whether the contact head and the socket is engaged in place when the contact switch is turned on, thereby realizing the visualization of the engagement depth. Wherein, the engagement depth can be understood as the amount of extrusion of the contact point by the contact head. For example, the mark is T-shaped, the horizontal line part is parallel to the length side of the plate-shaped contact head, and the vertical line part is parallel to the longitudinal side of the plate-shaped contact head. Therefore, in the final state when the contact switch is turned on, the horizontal line of the mark is blocked by the socket, and the vertical line is exposed as a whole or in large part, indicating at this point that the engagement of the plug to the socket has been completed. For maintenance personnel, this intuitive marking method can also greatly simplify the process of troubleshooting and daily maintenance. It should be appreciated that the position of the mark on the contact head body can be designed according to the requirements of the engagement depth. It should be appreciated that the selection of the engagement depth amount will affect the fatigue life of the elastic member, the degree of wear of the contact head and the contact point, and the contact reliability between the two. Therefore, an appropriate engagement depth helps to maintain a low level of wear while maintaining reliable contact and ensure the fatigue life of the elastic member. For example, the engagement depth is selected to be 3 to 6 mm, and the position of the mark is determined based on this. In addition to the T-shaped mark, circular, rectangular, triangular, rhombus, polygonal and even irregular shapes can also be considered, and shapes such as letters or numbers can also be considered.

In some embodiments of the present disclosure, the socket 2 comprises at least two baffles 24. The baffles 24 are constructed on the end surface of the housing 23 facing the plug 1, and the contact head 11 contacts the contact point 22 through the intermediate space formed between the baffles 24 and the open portion 233 in sequence.

It can be seen that the design of the baffle provides a preliminary limit function and a movement guide function for the contact head to be inserted into the socket, so that it can smoothly and reliably enter the open portion and the internal space of the socket housing to contact the contact point, and also achieves the protection level IP2X requirements. And, the baffle can be used in conjunction with the limiting portion mentioned above to regulate the position of the contact head in a more comprehensive manner. To this end, the spacing between the baffles can be set to be greater than or equal to the spacing of the receiving space formed by the limiting portion in the thickness direction of the housing. In addition, the baffle can also play a role in shielding external impurities, such as dust, sand, water, etc. to a certain extent, reducing their chances of entering the interior of the socket and protecting the normal operation of components such as the plug and the elastic member. The baffle extends exemplarily along the length direction of the housing and are aligned with each other to provide a clear engagement path. The design of the baffle cooperating with the through opening can better meet the requirements of the protection level of the contact switch.

It can also be seen in conjunction with FIG. 3 that the socket 2 comprises a first threaded fastener 25 and a second threaded fastener 26, wherein the first threaded fastener 25 fixes the housing 23 along the thickness direction of the housing 23, and the second threaded fastener 26 is used for wiring and is accessible from outside the housing 23.

The threaded fastener can be, for example, a bolt, a screw, a stud or other threaded components used for fixing. Here, the first threaded fastener is used to fix the socket, and the second threaded fastener is used for wiring and constraining the wiring harness. Wherein, the threaded connection can ensure the stability and firmness of the socket structure, and the socket structure can also be disassembled when necessary. The second threaded fastener, such as a nut, can also be accessible from outside the housing, so that when necessary, such as during the maintenance stage, the resistance can be measured by contacting the second threaded fastener without disassembling the socket through an electric meter such as a multimeter to determine the conduction condition, which improves maintenance efficiency and reduces maintenance costs.

It can also be seen that the second threaded fastener is arranged or extended in a plane perpendicular to the thickness direction. The entire housing can be understood as a bottom-fixed form. Therefore, when wiring, the second threaded fastener can be loosened more thoroughly first to facilitate wiring, and then the second threaded fastener can be tightened after the wiring is completed. This facilitates wiring while ensuring the position of the socket to be fixed. To this end, it can be appreciated that the housing is provided with corresponding threaded holes for threaded connection.

Further, the socket 2 comprises a nut 27 that cooperates with the second threaded fastener 26, the end surface of the housing 23 along the thickness direction is provided with an opening, and the nut 27 is accessible from outside the housing 23 through the opening.

Thus, the nut can also be accessible from outside the housing through the opening, so that, for example, during maintenance, the nut can be accessed from outside the housing without disassembling the socket through a multimeter, and the resistance can be measured to check the conduction condition, which improves the convenience and flexibility of maintenance. Specifically, in some installation positions of the socket, the bottom of the socket may be blocked, but the opening on the side surface of the housing is still in an open state to the outside, so that inspection can still be achieved in a convenience manner. The opening is, for example, a circular hole with a diameter of 2.5 mm, and there are two of such openings. Those skilled in the art can adjust the corresponding features of the opening accordingly according to the actual situation, such as the position, quantity, size and other features of the nut.

It can also be seen in conjunction with FIG. 3 that the inner side wall of the housing 23 is configured with an abutment portion 234, and the bottom surface of the housing 23 along the thickness direction is configured with a limiting column 235, a guide structure 236 and a receiving portion 237 for receiving the nut 27. The elastic member 21 is clamped on the outer wall of the receiving portion 237 through the limiting column 235 and the guide structure 236. In the initial state where the contact switch 100 is not turned on, the abutment portion 234 abuts against the avoidance portion 211.

This technical solution gives an example of a fixing method of the elastic member. The elastic member is fixed or limited by the abutment portion, the limiting column, the guide structure and the receiving portion commonly. Specifically, a portion of the elastic member is wound around the limiting column, and another portion of the elastic member is attached to the arc-shaped outer surface of the guide structure. Finally, the end portion of the elastic member abuts against the side surface of the receiving portion along the length direction and hooks on the side surface of the receiving portion in the width direction, thus completing the limiting, and providing a stable support and clamping point for the elastic member. Here, the limiting column can also be used as a positioning element during assembly of the housing, such as the assembly of the first sub-housing and the second sub-housing, the guide structure can also be used to fix the first threaded fastener, and the receiving portion is used to receive the nut. Therefore, these components have multiple functions, realizing full utilization of the internal space of the housing and components, avoiding waste of space, and improving resource utilization.

This technical solution also defines that in the initial state where the contact switch is not turned on, the abutment portion abuts against the avoidance portion, that is, the housing plays a pre-compression role on the elastic member, ensuring that the avoidance portion and the contact head are kept at a certain distance so as to prevent the contact head from possibly contacting the avoidance portion, which would cause the resistance to increase. And, this design form also defines the initial position of the elastic member comprising its free end and the contact point, avoiding displacement or shaking during use, so that it is stably located in the socket housing in the initial state, which can prevent the elastic member from accidentally moving due to external factors (such as vibration, collision, etc.) to a certain extent, thereby triggering the contact switch, and improving the reliability of the product.

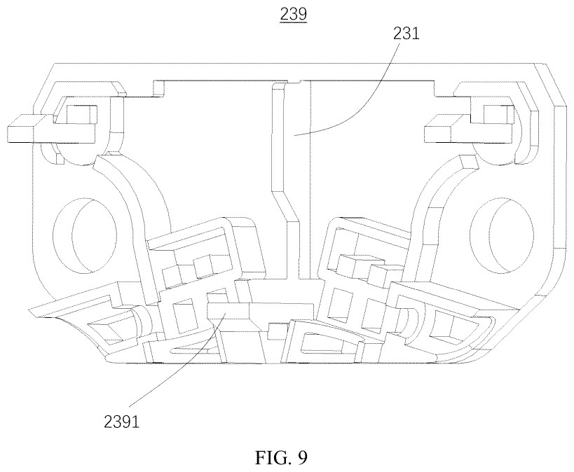

FIG. 9 is a three-dimensional view of a second sub-housing according to the present disclosure.

The elastic member 21 and the contact point 22 are arranged in the first sub-housing 238, the open portion 233 and the through opening 232 are opened on the first sub-housing 238, and the second sub-housing 239 is configured with a hook portion 2391, wherein when the first sub-housing 238 and the second sub-housing 239 are assembled, the hook portion 2391 is clamped to the through opening 232.

According to this technical solution, on the one hand, the assembly of the two sub-housings is realized by the clamp connection of the hook portion with the through opening, wherein the clamp connection design realizes the fast, stable and convenient assembly of the two sub-housings without the need for additional fasteners or complicated assembly processes. On the other hand, after the assembly is completed, the through opening can still communicate the internal space of the housing with the outside, thereby still being able to maintain the function of discharging impurities, and ensuring that the contact switch can operate well for a long time even in harsh environments.

In this regard, the second sub-housing can be provided with a plurality of hook portions at a plurality of locations, and can cooperate with various components of the first sub-housing. For example, as mentioned above, the limiting column is provided with a hole 2351 for engaging with the hook portion. When implementing the clamp connection, the hook portion can use its inclined surface to contact the end face of the hole, and deform the hook portion, so as to enter and pass through the hole. After passing through the hole, the hook portion is reset by the reaction force formed by the deformation and hooks the corresponding end surface of the hole or the step designed for this purpose, thereby establishing a clamp fit. In addition thereto, screw connection, welding, riveting, bonding, magnetic attraction and the like can also be considered.

The present disclosure also relates to a safety door, wherein the safety door comprises any of a contact switch 100 according to any of the above; and an elevator system 101, wherein the elevator system 101 comprises the above-mentioned safety door.

Therefore, the safety door and elevator system of the present disclosure integrate various embodiments and corresponding technical effects of the contact switch, which will not be repeated here. However, it should be appreciated that the safety door comprises various doors in the open and closed states that need to be monitored, such as the hall door, the car door of the elevator system, or the door of the access control system.

The specific embodiments described above in the present disclosure are only for describing the principles of the present disclosure more clearly, wherein each component is clearly shown or described to make the principles of the present disclosure easier to understand. Those skilled in the art may, without departing from the scope of the present disclosure, easily make various modifications or changes to the present disclosure. It should therefore be appreciated that these modifications or changes should be included in the scope of patent protection of the present disclosure.

What is claimed is:

1. A contact switch (100), wherein the contact switch (100) comprises a plug (1) and a socket (2), the plug (1) comprising a contact head (11) configured in a plate shape, the socket (2) comprising a housing (23), an elastic member (21) and a contact point (22) arranged in the housing (23), where the elastic member (21) comprises an avoidance portion (211) and a free end (212) extending toward the contact head (11) relative to the avoidance portion (211), and the contact point (22) is fixed to the free end (212) and extends toward the contact head (11) relative to the free end (212), wherein, when the plug (1) is inserted into the socket (2), the contact head (11) contacts the contact point (22) to turn on the contact switch (100) and to be spaced apart from the avoidance portion (211).

2. The contact switch (100) according to claim 1, wherein, a limiting portion (231) extending inward is configured in the housing (23), and the limiting portion (231) forms a receiving space (SP), wherein when the plug (1) is inserted into the socket (2), the contact head (11) enters the receiving space (SP) and is limited in a thickness direction of the contact head (11) through the limiting portion (231).

3. The contact switch (100) according to claim 1, wherein, the contact head (11) comprises a contact head body (116), a base material (114) disposed on the contact head body (116), and a contact layer (112) for contacting the contact point (22), where the base material (114) and the contact layer (112) are connected by thermal compounding.

4. The contact switch (100) according to claim 3, wherein, the contact layer (112) contains silver material, and the base material (114) contains copper material.

5. The contact switch (100) according to claim 3, wherein, a groove (1161) is provided on the side edge of the contact head body (116), the base material (114) is configured as a U-shaped structure with a joint portion (1141) configured on a side edge, wherein, the joint portion (1141) is engaged in the groove (1161), and the side edge and bottom edge of the U-shaped structure are respectively attached to a side edge and an end surface facing the socket (2) of the contact head body (116).

6. The contact switch (100) according to claim 1, wherein, the housing (23) is formed with a through opening (232) and an open portion (233), wherein, the open portion (233) is communicated with an internal space of the housing (23) and is used for the contact head (11) to enter, and the through opening (232) communicates the internal space of the housing (23) with the outside.

7. The contact switch (100) according to claim 1, wherein, an end surface of the contact head (11) along a thickness direction is configured with a mark (113), wherein, in an initial state where the contact switch (100) is not turned on, the mark (113) is visible to the outside, and in a final state where the contact switch (100) is turned on, the mark (113) is at least partially blocked by the socket (2).

8. The contact switch (100) according to claim 6, wherein, the socket (2) comprises at least two baffles (24), wherein, the baffles (24) are configured on the end surface of the housing (23) facing the plug (1), and the contact head (11) contacts the contact point (22) through an intermediate space formed between the baffles (24) and the open portion (233) in sequence.

9. The contact switch (100) according to claim 1, wherein, the socket (2) comprises a first threaded fastener (25) and a second threaded fastener (26), where the first threaded fastener (25) fixes the housing (23) along the thickness direction of the housing (23), and the second threaded fastener (26) is used for wiring and is accessible from outside the housing (23).

10. The contact switch (100) according to claim 9, wherein, the socket (2) comprises a nut (27) that cooperates with the second threaded fastener (26), and an end surface of the housing (23) along the thickness direction is provided with an opening, and the nut (27) is accessible from outside the housing (23) through the opening.

11. The contact switch (100) according to claim 10, wherein, an inner side wall of the housing (23) is configured with an abutment portion (234), a bottom surface of the housing (23) along the thickness direction is configured with a limiting column (235) a guide structure (236) and a receiving portion (237) for receiving the nut (27), and the elastic member (21) is clamped on an outer wall of the receiving portion (237) through the limiting column (235) and the guide structure (236), wherein, in an initial state where the contact switch (100) is not turned on, the abutment portion (234) abuts against the avoidance portion (211).

12. The contact switch (100) according to claim 6, wherein, the housing (23) comprises a first sub-housing (238) and a second sub-housing (239), the elastic member (21) and the contact point (22) are arranged in the first sub-housing (238), the open portion (233) and the through opening (232) are opened on the first sub-housing (238), and the second sub-housing (239) is configured with a hook portion (2391), where when the first sub-housing (238) and the second sub-housing (239) are assembled, the hook portion (2391) is clamped to the through opening (232).

13. A safety door, wherein the safety door comprises a contact switch (100) according to claim 1.

14. An elevator system (101), wherein the elevator system (101) comprises a safety door according to claim 13.
